(19) United States
(12) Patent Application Publication
(10) Pub. No.: US 2007/0105531 A1
(43) Pub. Date: May 10, 2007

(54) Dynamic Processing of Virtual Identities for Mobile Communications Devices

(75) Inventor: B. Steven Schroeder Jr., Dallas, TX (US)

Correspondence Address: FENWICK & WEST LLP, SILICON VALLEY CENTER, 801 CALIFORNIA STREET, MOUNTAIN VIEW, CA, 94041, US

(73) Assignee: ASCENNA MOBILE, INC., San Francisco, CA (US)

(21) Appl. No.: 11/554,568

(22) Filed: Oct. 30, 2006

Related U.S. Application Data
(60) Provisional application No. 60/734,022, filed on Nov. 4, 2005.
(60) Provisional application No. 60/748,626, filed on Dec. 9, 2005.
(60) Provisional application No. 60/748,625, filed on Dec. 9, 2005.

(51) Int. Cl. H04M 1/66

(52) U.S. Cl. 455/411; 713/168; 455/433

(57) ABSTRACT

Virtual identities are created, where the virtual identities correspond to the primary identity of a mobile communications device or are based on the authentication of a mobile communications device. In this way, the same mobile device can send communications from different identities (e.g., different phone numbers) and/or receive communications at different identities. In one implementation, a virtual identity platform includes an identity database that makes associations between virtual identities and primary identities.

### CROSS-REFERENCE TO RELATED APPLICATION

This application claims priority under 35 U.S.C. § 119(e) to each of the following U.S. Provisional Patent Applications: (a) Ser. No. 60/734,022, “Method for creating, disposing and managing identities from a mobile or similar communication device,” by B. Steven Schroeder, Jr., filed Nov. 5, 2005; (b) Ser. No. 60/748,626, “Method for receiving and placing inbound and outbound calls, respectively, to and from a virtual identity using a mobile or other communications device,” by Steve Schroeder, filed Dec. 9, 2005; and (c) Ser. No. 60/748,625, “Method for sending and receiving text, multimedia, email and other digital messages to and from a virtual identity using a mobile or similar communications device,” by Steve Schroeder, filed Dec. 9, 2005. The subject matter of all of the foregoing is incorporated herein by reference in their entirety.

### BACKGROUND OF THE INVENTION

1. Field of the Invention

This invention relates generally to the use of mobile communications devices, such as cell phones and wireless PDAs. More particularly, it relates to the real-time use of virtual identities on mobile communications devices, for example the ability to dial out from any of multiple phone numbers on a single cell phone or to receive calls on any of multiple phone numbers on a single cell phone.

2. Description of the Related Art

Mobile communications is growing in importance. With each passing day, the numbers and types of mobile communications devices is growing and end users are increasingly relying on their mobile communications devices for more of their communications needs. In addition, the variety of communications services available to end users is also growing. Traditional voice services have been augmented and sometimes even replaced by mobile voice (e.g. cell phones), instance messaging, text messaging, multimedia messaging, chat, IRQ, email and enhanced voice services such as push-to-talk. As a result of these trends, there is an ever-increasing number of communications services which can be accessed over an ever-increasing number of communications devices, in some instances using an ever-increasing number and/or variety of underlying communications networks. Wireless communications has become ever more powerful but also correspondingly more complex.

In mobile communications, end users typically interact using their mobile devices. However, mobile communications devices are usually tied to a single identity (e.g., a phone number) via a physical authentication mechanism such as a SIM card. This limitation means that all communications initiated by an end user from that specific device are originated using that specific identity. It also means that, in order for a communication to reach that specific device, the communication must have that specific identity as its destination. This limits the flexibility of mobile communications. For example, it largely prevents end users from communicating using multiple identities. For example, an end user might desire to use one phone number for business and one for personal. The end user typically cannot use both phone numbers on a single mobile phone, since the mobile phone is tied to a single SIM card and therefore limited to a single phone number as its identity.

One solution is to carry multiple devices, for example one mobile phone for business and a second mobile phone for personal. The obvious drawback is that the end user must use more than one device. Typically, each device would also require a separate account with separate charges, thus proliferating the number of accounts and charges paid by the end user. This problem is further aggravated as the number of available communications services also grows.

In a related approach, an end user might use multiple SIM cards rather than multiple devices, for example one SIM card for his business phone number and a second SIM card for his personal phone number. The end user uses one mobile device but physically switches SIM cards. This is inconvenient at best. In addition, although the end user can select any phone number by switching SIM cards, only one phone number can be active at any time. If the SIM card with the business phone number is installed, the user will not receive calls placed to the personal phone number.

Another approach is to install multiple identities on the physical authentication mechanism. For example, a single SIM card might contain multiple IMSIs, which map to phone numbers in the mobile network. However, this implementation has a poor user experience and requires a user to switch between the different profiles (IMSI) before placing a call. In addition, although end users have access to multiple identities, they usually can only use one identity at any given time. For example, assume that a SIM cards contains two phone numbers: X1 and X2 and that the user has currently selected phone number X1. Then, the mobile phone will act as if it is phone number X1 and calls placed from the phone must be placed from phone number X1. The phone cannot place calls from phone number X2, even though that number is supported by the SIM card, until the user first switches his selection to X2.

Yet another approach is to upgrade the entire existing infrastructure to support multiple mobile numbers in the network, for example based on 3GPP standards. However, this approach is a voice-centric approach and has many limitations with respect to messaging and other forms of communication. For example, when receiving an SMS, there is no indication of which identity has been used. As another example, the end user must switch identity profiles before sending an outbound SMS. Furthermore, MMS and other forms of communication are not supported. Identities also cannot be provisioned from the handset or from the web.

Thus, there is a need for an approach that supports the use of multiple identities on a single mobile communications device, and which preferably spans many forms of communications services and promotes ease of use and flexibility for the end user.

### SUMMARY OF THE INVENTION

The present invention overcomes the limitations of the prior art by providing virtual identities that correspond to the primary identity of a mobile communications device and/or the primary authentication mechanism used by a mobile network to which the mobile device is attached. In this way, the same mobile device can send communications from different identities (e.g., different phone numbers) and/or receive communications at different identities. In one implementation, a virtual identity platform includes an identity database that makes associations between virtual identities and primary identities.

In one aspect, a method for delivering a communication from a virtual identity for a mobile communications device to a recipient device includes the following steps. A communication from the mobile device is received. The communication includes a virtual identity code. The mobile device's primary identity is determined, for example during authentication of the mobile device. The virtual identity code and the primary identity (and/or the primary authentication mechanism) are used to determine a virtual identity for the mobile device. The communication is dynamically modified to include the virtual identity. The modified communication is delivered to the recipient device. In this way, it appears that the communication was sent from the virtual identity when, in fact, the primary identity is still used for delivery from the mobile device.

In another aspect, a method for delivering a communication from a sender device to a virtual identity for a mobile communications device includes the following steps. A communication is received, addressed to a virtual identity for the mobile device. The virtual identity is used to determine a primary identity for the mobile device. The communication is dynamically modified so that it is now addressed to the primary identity rather than to the virtual identity. The modified communication is delivered to the primary identity. The communication may also be modified by adding a virtual identity code to the communication. In this way, the recipient can tell that the communication was originally sent to a virtual identity.

This approach can be used with many types of communications, including for example voice messages, text messages and instant messages. Virtual identities can include phone numbers, email addresses and handles (e.g., for chat or IM). In one implementation, the conversion between virtual identity and primary identity is handled by a virtual identity platform, which may be either internal to or external to the mobile network to which the mobile device is connected.

Other aspects of the invention include methods for provisioning, managing and disposing of virtual identities, both via mobile devices and non-mobile devices. Yet other aspects include devices and systems corresponding to the approaches described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of a communications system according to the invention.

FIG. 2 is a chart illustrating one implementation of the identity database of FIG. 1.

FIGS. 3A and 3B are diagrams illustrating communications to and from a virtual identity, respectively.

FIGS. 4A-4B, 5A-5C and 6A-6C are diagrams illustrating communications to and from a virtual identity, using a specific GSM example.

### DETAILED DESCRIPTION OF THE PREFERRED EMBODIMENTS

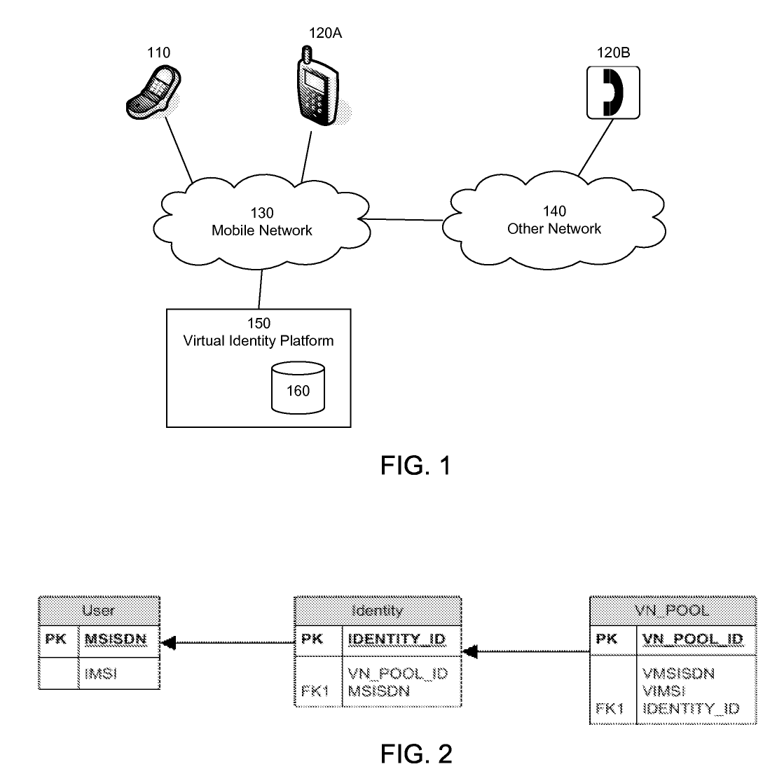

FIG. 1 is a block diagram of a communications system according to the invention. The system includes various communications devices 110, 120A, 120B, a mobile network 130, possibly other networks 140, and a virtual identity platform 150. Examples of mobile communications devices 110 include mobile handsets (e.g., cell phones), wireless PDAs (e.g., Treos and Blackberry), wireless broadband devices, or other devices that can connect to a mobile or wireless network for the purposes of communications (e.g. any Skype-enabled device, portable, handheld, PC, etc . . . ). Examples of mobile network 130 include both the GSM core (circuit-switched) and the GPRS core (packet-switched), CDMA, W-CDMA, UMTS networks, and also include wireless LAN networks spanning WiFi, WiMax or other radio network, and hybrid networks that span mobile and wireless LAN. Examples of networks 140 that are not mobile networks include the traditional public switched telephone network (PSTN), the wired Internet, and certain proprietary networks such as corporate wired LAN and WAN networks.

The mobile communications device 110 desires to communicate with one of the other devices 120, which could be either mobile 120A or not 120B. The mobile communications device 110 could be sending communications to the other device 120 and/or receiving communications from the other device 120. In this example, mobile devices 110, 120A are connected via the mobile network 130. For example, in most current mobile network architectures, a mobile device (i.e., cell phone) would connect to the mobile network (e.g., GSM network) through a base station subsystem (BSS) and mobile switching center (MSC). In a different situation, the mobile devices 110, 120A could connect to different mobile networks, which are then connected to each other either directly or indirectly. Non-mobile devices 120B typically are connected via some other network 140. The networks 130, 140 are connected to each other, either directly or indirectly.

Different communications services may be available to the devices 110, 120. Examples of services that may be supported by mobile networks 130 include voice (including both circuit-switched and packet-switched, and VOIP), SMS (Short Messaging Service), MMS (Multimedia Messaging Service), chat/IM (Instant Messaging), push to talk and email.

In order to transmit communications between devices, the identity (e.g., phone number) of the devices (or at least one of the devices, for example the recipient or B-Party) is generally required. Mobile devices 110 typically have a single identity that is somewhat hardwired to the device. This identity will be referred to as the primary identity for the device. In many cases, the primary identity is determined during authentication of the mobile device. For example, GSM cell phones are identified by their IMSI, which is stored in the SIM card installed on the device. In general, each SIM card stores one phone number. In order to change phone numbers for the cell phone, the SIM card must be replaced by a different SIM card in most cases. Thus, a single conventional SIM card does not allow a user to receive phone calls at two different phone numbers on a single cell phone.

The virtual identity platform 150 addresses this problem. The platform 150 is used by the mobile network 130 and can be implemented within the mobile network and/or external to the mobile network (as shown in FIG. 1). The virtual identity platform 150 includes an identity database 160 that implements the dynamic processing of virtual identities (i.e., identities other than the primary identity). The database makes associations between virtual identities and the corresponding primary identity. For example, if a cell phone user desired to use a business phone number, a personal phone number and an emergency phone number, the database would make the association between these three virtual phone numbers and the IMSI. Alternately, the IMSI could be used as one of the three phone numbers, with the other two implemented as virtual phone numbers tied to the IMSI. The processing is dynamic in the sense that the conversion between primary and virtual identities occurs in real-time as part of the delivery of communications.

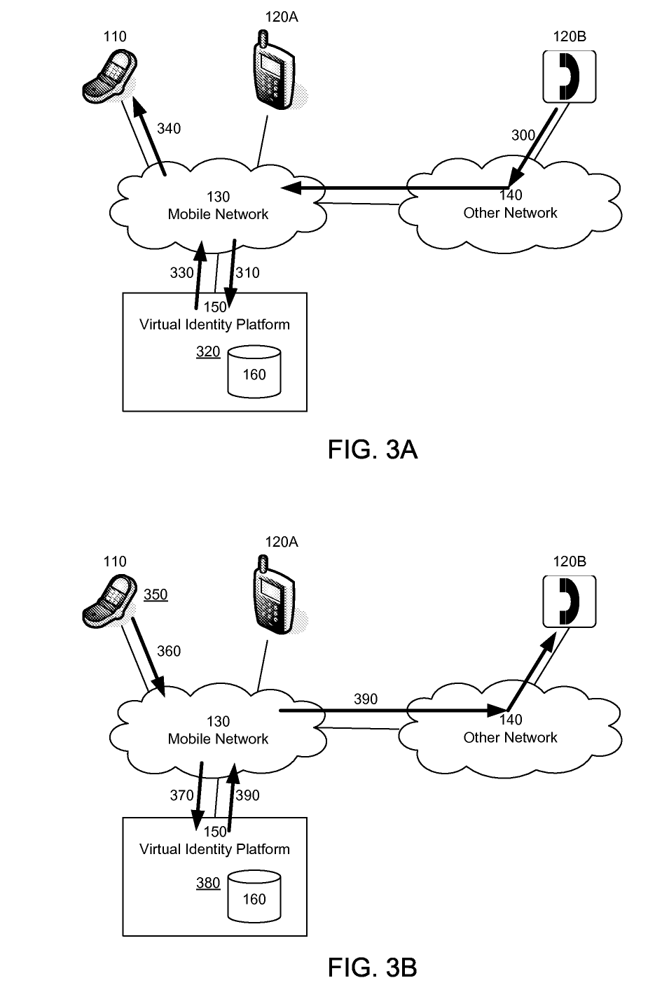

FIG. 2 is a diagram illustrating an example implementation of the identity database 160. In this example, there are three primary tables labeled “User,” “Identity” and “VN_POOL.” The User table provides the primary identity for a user. It is a one to one mapping between MSISDN and IMSI. The Identity table lists all the virtual identities for a user. It provides a mapping between the virtual identity code (IDENTITY_ID) and MSISDN (or IMSI) to a tag for the virtual identity (VN_POOL_ID). The VN_POOL table is a pool of available virtual identities. The virtual identities are VMSISDN or VIMSI in this example.

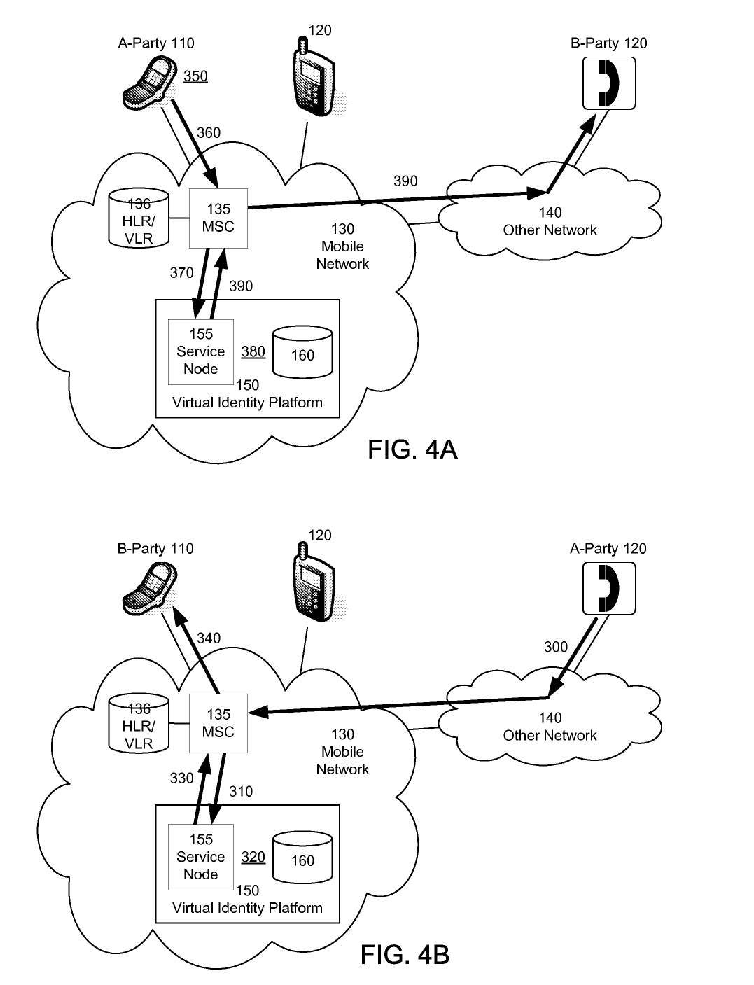

FIGS. 3A and 3B are diagrams illustrating communications to and from a virtual identity for the mobile device 110, respectively. The communication could be a voice call, text message, instant message, or other form of communication. In FIG. 3A, device 120B is the sender and mobile device 110 is the recipient. The sender 120B sends 300 a communication to the mobile device 110, addressed using a virtual identity for the mobile device 110. When the communication reaches the mobile network 130, the mobile network accesses 310 the virtual identity platform 150. For example, part or all of the communication may be sent 310 to the virtual identity platform 150. The platform 150 accesses the identity database 160 and determines 320 the primary identity that corresponds to the virtual identity. This information is communicated 330 to the mobile network 130. For example, the communication might be sent 330 back to the mobile network 130 but with the primary identity included, and possibly with some indicator of the virtual identity or that the communication was originally sent to a virtual identity. The mobile network 130 sends 340 the communication to the primary identity of the mobile device 110.

FIG. 3B illustrates communication in the reverse direction. Mobile device 110 is the sender and device 120 is the recipient. The mobile device 110 has multiple virtual identities from which the communication can be sent. The user determines 350 which virtual identity is to be used for this communication and the mobile device 110 sends 360 the communication to the mobile network 130. The communication includes an indication of which virtual identity is being used. In order to operate properly, some protocols may require that the primary identity of the mobile device 110 be identified as the sending identity in the transmission 360 from the mobile device 110 to the mobile network 130. In that case, a flag or other indicator signals which of the virtual identities is to be used. The virtual identity platform is accessed to determine the virtual identity. In one approach, the communication is sent 370 to the virtual identity platform 150, where the identity database 160 is used to insert 380 the virtual identity as the sending identity in the communication. The revised communication is then sent 390 to the recipient 120.

The processing of the communications in the use of virtual identities is dynamic in the sense that the virtual identity platform 150 modifies the communication in real-time as part of the delivery process. One advantage of this approach is the ability to communicate using multiple identities for a single device. For example, multiple phone numbers can be used at a single device. In addition, new forms of identity can also be supported. For example, conventional text messaging is often based on sending text to a phone number. However, using the approach described above, in certain situations, virtual identities that are more similar to email addresses could be used for text messaging. The sender would send the text message to the email-like address (assuming this was supported by the rest of the network). The virtual identity platform 150 would handle the conversion between the email-like address and the primary identity for the phone, thus allowing delivery of the test message to the mobile phone. Examples of virtual identities include phone numbers (both for voice and for other messaging services such as SMS, MMS, push-to-talk, video conferencing, etc.) and messaging identities (e.g., email addresses for SMS, MMS or email; and handles for IM or chat).

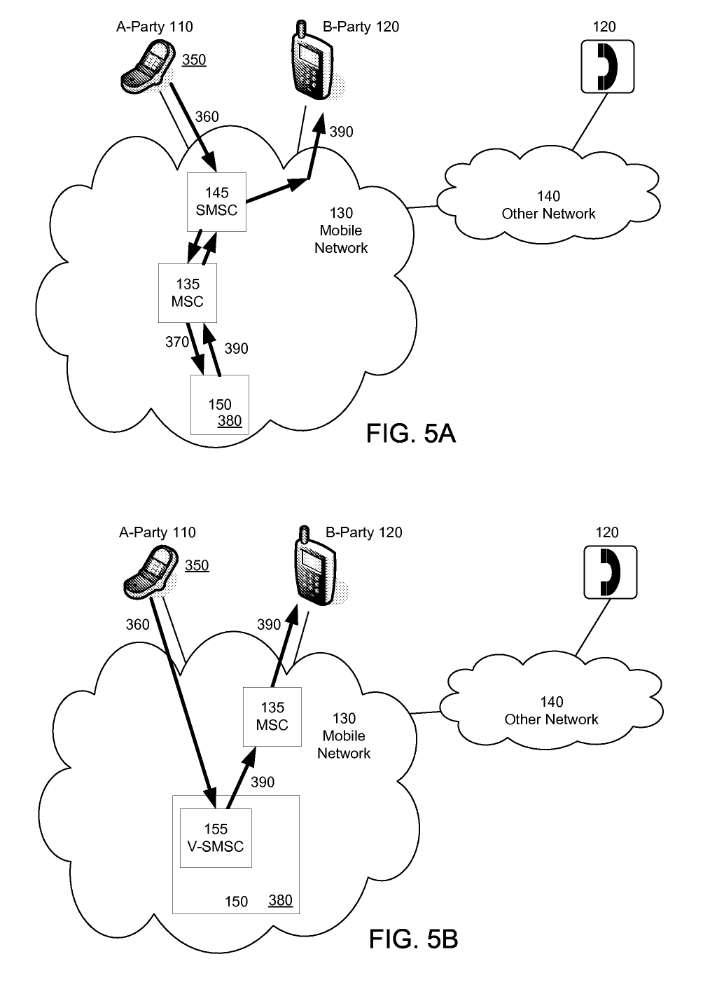

FIGS. 4-6 illustrate a specific example. This example is based on a 3GPP compliant GSM network. The mobile communications device 110 is a cell phone. In this implementation, client software is installed on the cell phone 110 to implement the virtual identity management functionality at the cell phone 110. This software could be installed on the SIM card, on the phone operating system, or embedded on a hardware chip, for example. The primary identity is derived from the IMSI inherent to the SIM card installed on the cell phone 110. The mobile network 130 is the current cell phone network, for example the GSM core.

The virtual identity platform 150 is implemented internal to the network in this example. In this implementation, the virtual identity platform 150 includes a virtual identity database 160, an identity management server, an identity management web server and a network service node 155. The identity database 160 maps virtual identities to the primary authentication mechanism inherent to the network (i.e., to primary identities). In the GSM example, this is the IMSI and MSISDN. The identity management server provides APIs to handle provisioning and management of identities from the client, from other network elements, or from third party modules. The identity management web server provides user interfaces for provisioning and management of identities via the web. The network service node 155 connects the virtual identity platform 150 to other network elements in the mobile network 130. It performs conversions and routing of communications using the chosen virtual identity. Multiple network service routers (i.e., network service nodes 155) may exist for different types of communications, for example voice, SMS, and MMS (or others, such as IM).

In this example, provisioning, assignment and management of the virtual identities is initiated on-demand by the end user through a handset client user interface, web service, or other client module (including for example web or PC applications). Client software modules residing on the mobile device 110 or other client (such as a PC if the end user is accessing the system through a PC) facilitate communication to and from the identity management server. This software is responsible for synchronizing identity data and for providing common identity provisioning and management services on a variety of devices. Virtual identities can be acquired, managed and/or disposed of via a common framework and software API. Many of these operations can be carried out on non-mobile devices, including for example internet, intranet or extranet portals, WAP gateways or other content gateways. In addition, the provisioning and management of services can take form using a variety of protocols and methods depending on the software supported on the device. For example, the fully functional device handset API can support provisioning of identities from a user interface. However, in some cases, with no software required, a user can provision or dispose of virtual identities using a set of SMS commands within text messages, sent to a specific address on the network. The user may also chose to provision an identity through a web interface, either from the mobile device or from a PC. Provisioning by web interface is handled by the identity management web server.

In one implementation, the management of identities is implemented as follows. The authentication of the mobile device 110 on the network 130 identities the primary identity of the mobile device. In the GSM example, this is the IMSI on the SIM card. The list of identities corresponding to that primary identity is replicated to the mobile device 110. Real-time retrieval of this information from server to client (i.e., from the identity management server to mobile device 110) and background synchronization methods can be used to track the identity lists and also user preferences on the mobile device. The replication method could be carried out by the handset software (on demand, such as a sync), when starting the phone, or could be pushed from the network (e.g., by sending a special SMS text message). The information may be retrieved and/or synchronized using a variety of methods, including web services or HTTP, communication to remote services such as EJB or COM, direct database calls, TCP-IP socket communication and SMS data push. The data retrieved may be represented in a variety of forms, including for example XML files, flat files, database records and binary. There are many other ways to replicate this information from the identity management server to the phone or end-user device 110. Once the list of identities is available to the end user's mobile device 110, the end user can edit, delete and create new identities. If no identities are defined, the user might be automatically prompted to create an identity. These changes are propagated through to the identity database 160 via the identity management server.

When creating a new identity, the user chooses from a list of configurable services and/or properties associated with the identity. This can include but is not limited to virtual phone number, virtual email address, an icon to visually represent the virtual identity on the mobile device, a name for the virtual identity (for example, “business line”), a picture or image to represent the user's “avatar” which can be shown to others when establishing communication (similar to a visual caller id), and a ring-tone to be played with incoming calls and/or messages associated with the virtual identity. These options and/or properties are not required and can be prepopulated with default values or not used. The user may also change or delete previously created virtual identities.

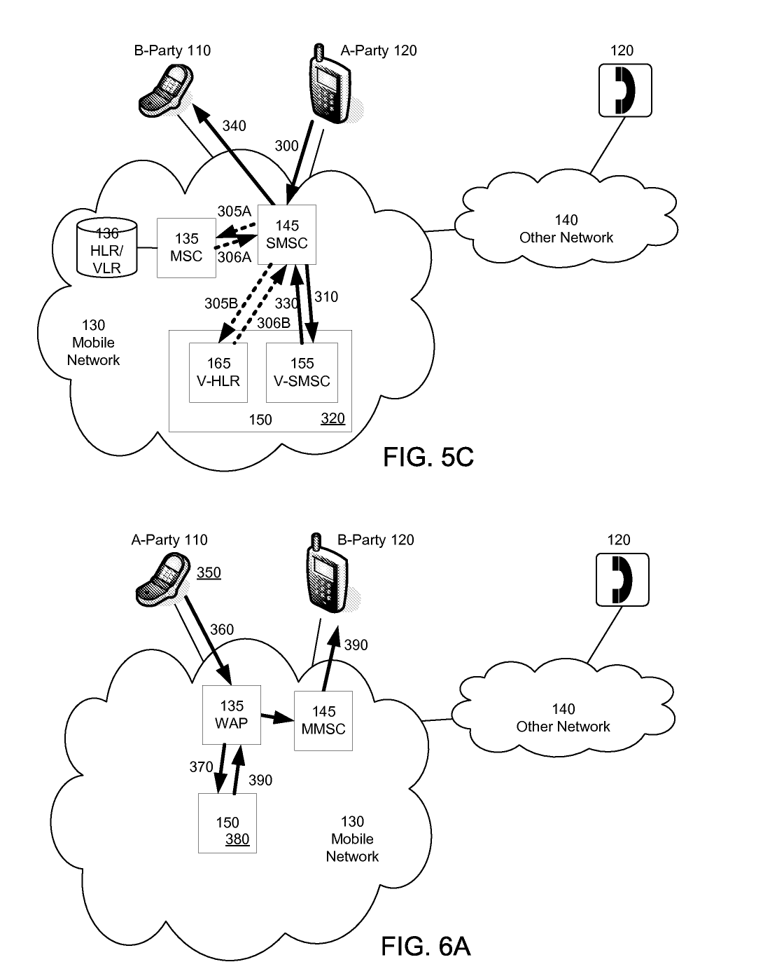

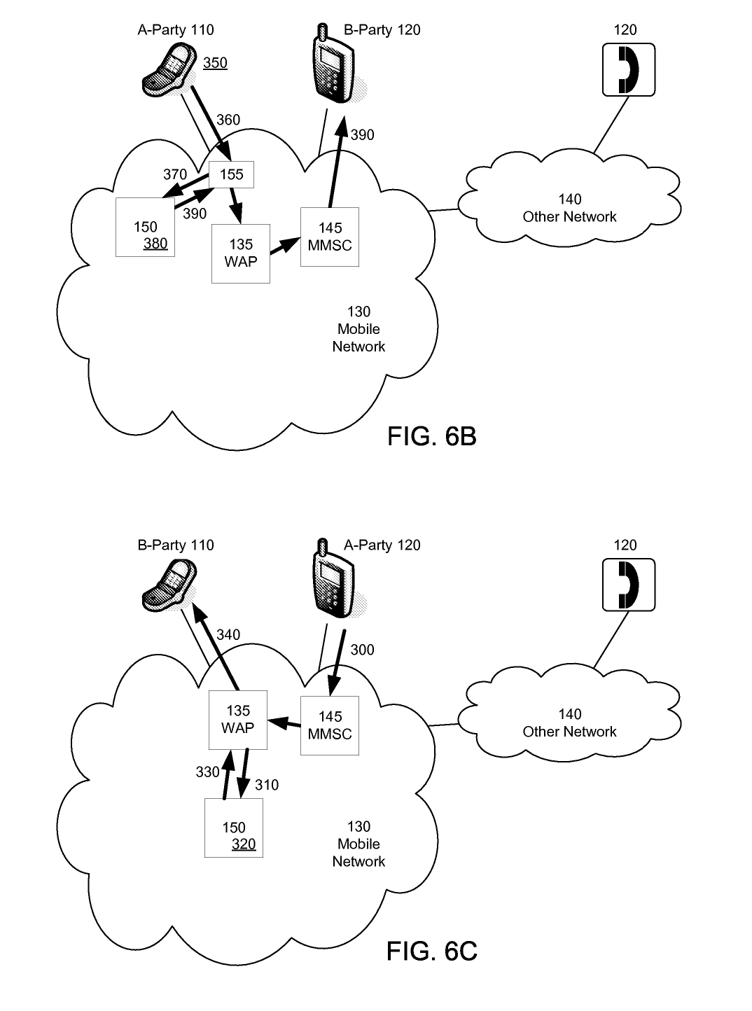

Returning to FIGS. 4-6, these figures illustrate different forms of communications from or to the mobile device 110. In the example of FIG. 4, the communications service is voice (e.g., phone calls) and the virtual identities for the mobile device 110 contain different phone numbers, for example one for personal use, one for business use, etc. In FIG. 5, the communications service is SMS and the virtual identities contain different phone numbers or email addresses. In the last example (FIG. 6), the communications service is MMS and the virtual identities contain different phone numbers or email addresses. In all of these examples, the sending party will be referred to as the A-Party and the receiving party as the B-Party.

FIG. 4A shows a situation where A-Party 110, a subscriber to the virtual identity service, initiates a call to B-Party 120, located on a circuit switched network in this example. The caller 110 indicates the identity to use in the call by using a virtual identity code within the called party phone number, for example 3102320432*1 where 3102320432 is the phone number for B-Party and *1 is the virtual identity code for A-Party. The virtual identity code can take the form of a suffix or prefix, and can optionally use different delimiters between the phone number and the number indicating the virtual identity to be used. In this example, 1 indicates the first virtual identity.

In this specific example, the handset 110 contains client software that initiates the outbound call through a user interface. If an identity has not been selected for which to initiate the call, the client software presents a menu of available identities for A-Party 110 to use in the pending call. Alternatively, other call menu items such as “call with identity” are available which select the identity prior to call initiation. In some cases, a user preference may be set to use a default identity selection, in which case the default identity associated with the particular contact or group will be automatically selected for calls to the contact or contacts associated with the group. The identity could also be preselected when responding to a call in the call logs (missed, dialed or received calls).

The handset software modifies 350 the outbound call string to include the virtual identity code, which is a virtual sender code in this example. The identity database 160 contains information that maps virtual identity codes with virtual identities. The virtual identity code is part of the identity profile information stored within the identity management server and replicated to the handset, as described above. For example, A-Party may have two virtual identities (i.e., phone numbers). These two virtual identities may correspond to the virtual identity codes of 1 and 2. Virtual identities in this example, phone numbers, are mapped to the virtual identity code for a primary identity (MSISDN and IMSI) of a mobile subscriber. Therefore, the virtual identity code, coupled with the primary identity (IMSI or MSISDN) of the mobile device 110, act as a unique identifier for a particular virtual identity. For example, if P is the primary identity, V is the virtual identity, and ID is the virtual identity code, then the two virtual identities may be defined by
P: 3105551212, V: 3103331000, ID:1
P: 3105551212, V: 3103331005, ID:2

The handset software allows the call to proceed on the mobile network as usual. If handset software is not available, the user can also manually perform the sequence of actions, such as including the virtual identifier when placing the call.

The call passes through the mobile network 130 to B-Party as follows. In the standard architecture of this example, the mobile device 110 attaches to the mobile network 130 via a mobile switching center (MSC) 135. The MSC 135 has access to a home location register/visitor location register (HLR/VLR) 136, which is the database that stores user information.

A-Party places 360 a call to B-Party. B-Party's phone number is 3102320432 but, since A-Party is using a virtual identity to place the call, the sent phone number is 3102320432*1. The MSC 135 receives 360 the call. The MSC 135 signals 370 the virtual identity platform 150 with the relevant call setup information. One possible implementation for triggering the virtual identity platform 150 is to register the virtual identity service in the HLR/VLR 136 with a CAP trigger sent to the virtual identity platform for all subscribers to the virtual identity service. Other implementations may signal the virtual identity platform 150 after recognizing a specific pattern within the call string, for example, all calls that begin with the prefix 100. Additional implementations for triggering calls through the virtual identity platform may be implementation specific.

The virtual identity platform 150 uses the virtual identity code and A-Party's primary identity (IMSI or MSISDN) to determine 380 the correct virtual identity for the call. The virtual identity platform 150 modifies 380 the call setup information to include an alternative calling party number (CPN), namely the number associated with the virtual identity, and connects 390 the call through the MSC 135. The call then proceeds as normal and is connected to B-Party, either within or external to the mobile network 130. However, when B-Party receives the call, it appears as if it were originated from A-Party's virtual identity.

In FIG. 4B, A-Party 120, initiates a call to B-Party 110, who is a subscriber to the virtual identity service. A-Party places the call to B-Party's virtual identity (e.g., a phone number that is not the IMSI or MSISDN for device 110). Based on the virtual phone number, the call is routed 300 to the mobile network 130 and to the MSC 135 of B-Party.

The MSC 135 recognizes the call as a call to a virtual identity and routes 310 the call setup information to the virtual identity platform 150. One example implementation is to register the virtual identity platform 150 as the serving HLR for virtual identity subscribers. In this case, the virtual identity platform 150 serves as a virtual HLR and instructs the MSC 135 to use the virtual identity platform upon call setup. One advantage of this approach is that the virtual numbers do not have to be provisioned in the HLR. In an alternate implementation, the HLR 136 is configured with the virtual number information and a trigger specified to the virtual identity platform 150 for all calls to this virtual number. Other implementations are possible and may depend on the specific technology being used in the mobile network 130.

The virtual identity platform 150 receives 310 a call setup message initiated from the MSC 135, with the virtual number as the destination. The service node 155 within the virtual identity platform 150 signals 330 to the MSC 135 to complete the call to the primary identity (in this case MSISDN), but the calling party number is also changed 320 to include the virtual identity code, indicating to the handset client 110 that the call was intended for a virtual identity. The call is connected by the mobile network 130 and received by B-Party 110, with the virtual identity code attached to the calling party number. This identifies to the end user which line (i.e., which virtual phone number) is being called.

Additionally, if available, software on the handset intercepts the call and scans the caller ID for the virtual identity code. If a virtual identity code is shown, the software determines which virtual identity is associated with the virtual identity code and displays the appropriate call notification message (e.g., call to “business” line), optionally with a distinct ring or other audio/visual or physical cue. The phone could also contain LEDs that flash different colors based on the identity being called. The user, B-Party 110, accepts the call as normal.

In an alternate embodiment, the call is terminated at a soft switch, and then forwarded to the primary mobile number.

FIG. 5A is a diagram illustrating an example on a mobile GSM network using SMS as the communications method. In this example, A-Party 110, a subscriber to the virtual identity service, sends an SMS message to B-Party 120, another mobile subscriber, via the mobile network 130. In the standard SMS architecture, the mobile network 130 contains the MSC 135 and a short message service center (SMSC) 145.

The SMS message can be sent using the native SMS application on the mobile device 110, or a customized application specifically for sending virtual messages. If the native SMS application is used, A-Party 110 specifies the identity to be used using a virtual identity code within the destination address. Alternatively, software on the mobile handset may intercept 350 a message sent by the native SMS application or, in some cases, initiate 350 the outbound message.

The result is an SMS message sent 360 from the handset 110 to the mobile network 130, which includes in the outbound call string (destined for B-Party) the virtual identity code for the virtual identity used by A-Party. Within the mobile network 130, the SMSC 145 attempts to deliver the message through the MSC 135, which relays 370 the message to the virtual identity platform 150 with the relevant message setup information. The virtual identity platform 150 takes the virtual identity code and A-Party's mobile subscriber number (i.e., primary identity) to determine 380 the correct virtual identity to be used for the message. The platform 150 modifies 380 the message detail to include an alternative calling party number (CPN) in the “from” address of the SMS, namely the number associated with the virtual identity. The platform 150 routes 390 the modified message to the mobile network SMSC 145 for store and forward message routing.

FIG. 5B shows an alternate embodiment in which the virtual identity platform 150 includes a virtual SMSC (V-SMSC) 155. In this case, the SMSC address on the handset is configured to the V-SMSC 155 within the virtual identity platform 150 and the message is delivered 360 to the V-SMSC 155 rather than the SMSC 145. The virtual identity platform 150 makes the address conversion 380 as before. The V-SMSC 155 can send 390 the message directly to the MSC 135, but in this case it must perform the store and forward function of the SMSC. It is preferred that the V-SMSC use the capabilities of the SMSC 145 in the mobile network 130. In general, it is preferred that the SMSC 145 be used for store and forward.

In FIG. 5C, A-Party 120 sends 300 an SMS message to B-Party 110, who is a subscriber to the virtual identity service. A-Party 120 can be a mobile subscriber within or external to the mobile network 130, or a non-mobile device/interface that interfaces with the mobile network 130, for example, a third party SMS gateway or web service. In the example of FIG. 5B, A-Party is another mobile user.

Returning to FIG. 5C, the message is routed 300 to the mobile network 130 of the B-Party 110. Within the mobile network 130, the SMSC 145 receives 300 the message. Within the mobile network 130, the V-SMSC 155 within the virtual identity platform 150 is configured as the serving MSC for the virtual number. This can be implemented in several ways. One possible implementation is to configure the virtual identity in the HLR 136 connected to the MSC 135 and/or SMSC 145 (arrows 305A, 306A). Another possible implementation is to use a virtual HLR (V-HLR) 165 located in the virtual identity platform 150 to determine the correct MSC 135 for the virtual number. In this case, the mobile network 130 communicates 305B, 306B with the V-HLR 165. In either case, the mobile network 130 identifies the virtual number destination as associated with the virtual identity service and triggers 310 the virtual identity platform 150 for message routing.

Ultimately, the SMSC 145 routes 310 the message to the V-SMSC 155 for delivery, through the MSC 135 as described above. From the standpoint of the SMSC 145, the V-SMSC 155 looks like an MSC endpoint. The V-SMSC 155 modifies 320 the message details to include the real MSISDN for delivery purposes. The “from” field is modified 320 to include the virtual identity code, signaling to the handset that the message is to a virtual identity.

The V-SMSC 155 routes 330 the modified SMS message back to the SMSC 145 for delivery 340. Alternatively, the V-SMSC 155 can attempt to deliver the message directly by routing the message to the serving MSC 135 for the primary identity of the subscriber B-Party 110.

Once the message arrives on the handset, the message is displayed with the virtual identity code in the “from” field to indicate which identity the message was sent to. This is displayed directly to the user when there is no software on the handset.

If software is on the handset, the software intercepts the message and scans the “from” field for the virtual identity code. If a virtual identity code is shown, the software determines which virtual identity is associated with the virtual identity code and displays the appropriate message notification message (e.g., message to “business” identity), optionally with a distinct ring or other audio/visual or physical cue.

The user accepts the message as normal. The message could be represented with a different icon or other indicator, or delivered to a separate mailbox.

In FIG. 6A, A-Party 110, a subscriber to the virtual identity service, sends a message to B-Party 120 using a MMS/Email application (could be the standard application) as usual on the mobile device. In this example, the mobile network 130 includes the multimedia message service center (MMSC) 145 and WAP gateway 135.

Software on the mobile handset intercepts the outbound message and, if an identity has not been selected for which to initiate the call, presents a menu of available identities for A-Party to use in the pending message. Alternatively, other call menu items such as “send SMS/MMS/Email with identity” are available which select the identity prior to message creation. In some cases, a user preference may be set to use a default identity selection, in which case the default identity associated with the particular contact or group will be automatically selected for messages to the contact or contacts associated with the group. The software on the handset can either intercept a message created by the native messaging application, be a customization of the native messaging application, or an entirely new application created specifically for the purposes of sending on outbound message using identities.

In the case of MMS/Email, the handset software modifies 350 the HTTP header to include an additional field to indicate the identity to be used (virtual identity code). This information can also be supplied in the MMS header or MMS message itself. The virtual identity code and a mobile subscriber act as a unique identifier for a particular identity. The handset software allows the message to proceed on the mobile network as normal. The message is uploaded 360 through the WAP gateway 135. The WAP gateway 135 contacts 370 the virtual identity platform 150 to determine the correct virtual MSISDN to use and modifies 380 the message to include the correct header information, removing the virtual identity code and posting 390 the message as normal to the MMSC 145, including the modified virtual MSISDN address.

FIG. 6B shows an alternative where the virtual identity platform 150 acts as a WAP gateway proxy 155. The proxy 155 intercepts 370 and modifies 380 “from” details within outbound MMS messages before hitting the WAP gateway 135. The WAP gateway 135 then forwards 390 the message to the MMSC 145 as normal. The MMSC 145 stores the message and delivers as usual.

An alternate implementation is for the virtual identity platform 150 to act as a Radius server proxy, which connects to the RAS and Radius server and provides the virtual identity information to the WAP gateway directly when authenticating the request.

In FIG. 6C, A-Party 120 sends an MMS/Email to B-Party 110, who is a subscriber to the virtual identity service. The MMSC 145 receives 300 and stores the message associated with the virtual identity (virtual number or email). When attempting to deliver the message, the MMSC 145 sends an SMS control message to the user. The SMS control message is delivered using the same capability as in FIG. 5C. The user views the message and initiates download of the MMS message using the handset, which requests the message from the MMSC 145 through the WAP gateway 135.

The WAP gateway 135 detects a virtual identity code in the HTTP header request, which is present as a result of the handset software. This information can also be supplied in the MMS header or MMS message itself. The WAP gateway 135 contacts 310 the virtual identity platform 150 to determine 320 the correct virtual MSISDN to be used when retrieving the message from the MMSC 145. This is identified by MSISDN and the virtual identity code. The virtual MSISDN is then passed 330 to the MMSC 145 to look up the appropriate message in the MMSC 145 and present 340 the message to the user.

An alternate implementation is for the virtual identity platform 150 to act as a Radius server proxy, which connects to the RAS and Radius server and provides the virtual identity information to the WAP gateway directly when authenticating the request.

One advantage of this approach over conventional approaches is the ability to facilitate messaging communication using multiple numbers and/or mobile email addresses with a single mobile device. Currently, a SMS and MMS address is tied to the mobile device and/or SIM card. A one-to-one correlation exists between a SMS/MMS destination and a mobile phone number/email address. In markets where SMS/MMS interoperability is present, a user can distribute his/her mobile phone number to use as a SMS/MMS destination address. In markets where SMS/MMS interoperability is not present, a user can distribute a single mobile email address as a SMS/MMS destination address, which is tied to the handset or SIM card. The approach described above essentially decouples the SMS/MMS/Email destination address from the handset or SIM card and allows the user to send and receive messages from a single handset using different identities.

Although the detailed description contains many specifics, these should not be construed as limiting the scope of the invention but merely as illustrating different examples and aspects of the invention. It should be appreciated that the scope of the invention includes other embodiments not discussed in detail above.

For example, in lieu of the mobile device, any network enabled computing device may be used so long as there is access to the identity database 160. In alternate embodiments, an internet or VoIP phone carrier could query an end user's identity profile to get a list of the relevant identities. This information would tell the internet or VoIP phone carrier which identities a user has available for communitication. As another example, the call initiation method may be SIP instead of circuit switched mobile network protocols, e.g. SS7. The voice protocol may be VoIP.

Devices without handset software can also use the virtual identity code mechanism, for example in manual dial to place or receive calls using their virtual identity. The MSC can route call setup and other messages through the enhanced services platform, or the ESP can act as an additional HLR with standard routing information for virtual MSISDNs. The virtual identity service can be implemented outside of the mobile network (no MSC) and/or within a VoIP-only network. Call routing would typically be done using SIP in this case.

The invention also is not limited to a single form of communication, and includes SMS, MMS, and other forms of messaging that are authenticated on the mobile network with a single identity (SIM/IMSI in GSM for instance). The examples above were primarily in the context of GSM cell phones, but other networks and devices can also be used, for example CDMA. In general, the identities can be stored irrespective of the network or device. For example, identities could be stored in a central database that is independent of the network transport or device. The identities could span not only the mobile network, but also fixed line networks, internet addresses, etc. For example, a secondary identity could be a fixed line business line or home line.

In this way, a user can communicate using his/her identity from any device and on any network. For example, a user might have two cell phones: one on carrier A and another on carrier B. The identity database might reside external to both networks. However, the virtual identity platform could include network service nodes on each of the networks for routing purposes.

As another example, assume that a user has two cell phones A and B on networks A and B, with identities (phone numbers) ID-A and ID-B. Normally, the user can use cell phone A on network A only with ID-A and cell phone B on network B only with ID-B. However, with virtual identities, the user can set up ID-B as a virtual identity for cell phone A and set up ID-A as a virtual identity for cell phone B. Then, the user can use either identity from either device, and also with either network.

As a final example, the end user can save virtual identities (i.e., virtual phone number) in the phonebook with the identity information attached. Then the phonebook contact can be used for inbound/outbound voice and SMS without any other interaction, as normal. Each phonebook contact is associated with a specific identity.

Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

What is claimed is:

1. A method for delivering a communication from a virtual identity for a mobile communications device to a recipient device, the method comprising:
receiving a communication from the mobile device, the communication including a virtual identity code;
determining a virtual identity for the mobile device based on the virtual identity code and on a primary authentication mechanism of the mobile device to a mobile network;
dynamically modifying the communication to include the virtual identity; and
delivering the modified communication to the recipient device.

2. The method of claim 1 wherein the virtual identity is a phone number.

3. The method of claim 1 wherein the virtual identity is an email address.

4. The method of claim 1 wherein the virtual identity is a handle.

5. The method of claim 1 wherein the virtual identity code is a suffix or prefix added to an identity of the recipient device.

6. The method of claim 1 wherein determining a virtual identity for the mobile device comprises:
determining a primary identity for the mobile device during authentication of the mobile device to a mobile network; and
determining a virtual identity for the mobile device based on the virtual identity code and the primary identity.

7. The method of claim 6 wherein the primary identity is IMSI or MSISDN.

8. The method of claim 6 wherein the primary identity is tied to hardware on the mobile device.

9. The method of claim 1 wherein the communication is a voice message.

10. The method of claim 1 wherein the communication is a text message.

11. The method of claim 1 wherein the communication is an instant message.

12. The method of claim 1 wherein the steps of determining a virtual identity and dynamically modifying the communication occur within a virtual identity platform.

13. The method of claim 12 wherein the virtual identity platform contains an identity database that makes associations between virtual identities and the corresponding primary authentication mechanism of the mobile device.

14. The method of claim 12 wherein the virtual identity platform contains an identity management server for dynamically modifying the communication to include the virtual identity.

15. The method of claim 12 wherein the virtual identity platform is located internal to a mobile network to which the mobile device is connected.

16. The method of claim 12 wherein the virtual identity platform is located external to a mobile network to which the mobile device is connected.

17. The method of claim 1 wherein:
the communication is a voice message;
the step of receiving a communication from the mobile device comprises receiving the voice message at an MSC;
the step of determining a virtual identity for the mobile device comprises:
the MSC signalling a virtual identity platform with call setup information for the voice message; and
the virtual identity platform determining the virtual identity for the mobile device based on the virtual identity code and the primary authentication mechanism of the mobile device; and
the step of dynamically modifying the communication comprises the virtual identity platform including the virtual identity as an alternative calling party number for the voice message.

18. The method of claim 1 wherein:
the communication is an SMS message;
the step of receiving a communication from the mobile device comprises receiving the SMS message at an SMSC and relaying the SMS message to an MSC;
the step of determining a virtual identity for the mobile device comprises:
the MSC signalling a virtual identity platform with call setup information for the SMS message; and
the virtual identity platform determining the virtual identity for the mobile device based on the virtual identity code and the primary authentication mechanism of the mobile device; and
the step of dynamically modifying the communication comprises the virtual identity platform including the virtual identity as an alternative calling party number for the SMS message.

19. The method of claim 1 wherein:
the communication is an SMS message;
the step of receiving a communication from the mobile device comprises receiving the SMS message at a virtual SMSC located within a virtual identity platform;
the step of determining a virtual identity for the mobile device comprises the virtual identity platform determining the virtual identity for the mobile device based on the virtual identity code and the primary authentication mechanism of the mobile device; and
the step of dynamically modifying the communication comprises the virtual identity platform including the virtual identity as an alternative calling party number for the SMS message.

20. The method of claim 1 wherein:
the communication is an MMS/email message;
the step of receiving a communication from the mobile device comprises receiving the MMS/email message at a WAP gateway;
the step of determining a virtual identity for the mobile device comprises the WAP gateway and/or a virtual identity platform determining the virtual identity for the mobile device based on the virtual identity code and the primary authentication mechanism of the mobile device; and
the step of dynamically modifying the communication comprises the virtual identity platform including the virtual identity as an alternative calling party number for the MMS/email message.

21. The method of claim 1 wherein:
the communication is an MMS/email message;
the step of receiving a communication from the mobile device comprises receiving the MMS/email message at a WAP proxy;
the step of determining a virtual identity for the mobile device comprises the WAP proxy and/or a virtual identity platform determining the virtual identity for the mobile device based on the virtual identity code and the primary authentication mechanism of the mobile device; and
the step of dynamically modifying the communication comprises the virtual identity platform including the virtual identity as an alternative calling party number for the MMS/email message.

22. A method for delivering a communication from a sender device to a virtual identity for a mobile communications device, the method comprising:
receiving a communication addressed to a virtual identity for the mobile device;
determining a primary identity for the mobile device;
dynamically modifying the communication to be addressed to the primary identity; and
delivering the modified communication to the primary identity.

23. The method of claim 22 wherein the step of dynamically modifying the communication further comprises adding a virtual identity code to the communication, the virtual identity code and the primary identity together identifying the virtual identity.

24. The method of claim 22 wherein the steps of determining a primary identity and dynamically modifying the communication occur within a virtual identity platform.

25. The method of claim 22 wherein:
the communication is a voice message;
the step of receiving a communication addressed to a virtual identity comprises receiving the voice message at an MSC;
the step of determining a primary identity for the mobile device comprises:
the MSC signalling a virtual identity platform with call setup information for the voice message; and
the virtual identity platform determining the primary identity for the mobile device based on the virtual identity; and
the step of dynamically modifying the communication comprises the virtual identity platform modifying the voice message to be addressed to the primary identity.

26. The method of claim 22 wherein:
the communication is an SMS message;
the step of receiving a communication addressed to a virtual identity comprises receiving the SMS message at an SMSC;
the step of determining a primary identity for the mobile device comprises:
the SMSC signalling a virtual identity platform with call setup information for the SMS message; and
the virtual identity platform determining the primary identity for the mobile device based on the virtual identity; and
the step of dynamically modifying the communication comprises the virtual identity platform modifying the SMS message to be addressed to the primary identity.

27. The method of claim 22 wherein:
the communication is an MMS/email message;
the step of receiving a communication addressed to a virtual identity comprises receiving the MMS/email message at a WAP gateway;
the step of determining a primary identity for the mobile device comprises the WAP gateway and/or virtual identity determining the primary identity for the mobile device based on the virtual identity; and
the step of dynamically modifying the communication comprises the virtual identity platform modifying the MMS/email message to be addressed to the primary identity.

28. A computer readable medium containing software instructions to cause a processor system to execute a method comprising the steps of:
receiving a communication from the mobile device, the communication including a virtual identity code;
determining a virtual identity for the mobile device based on the virtual identity code and on a primary authentication mechanism of the mobile device to a mobile network;
dynamically modifying the communication to include the virtual identity; and
delivering the modified communication to the recipient device.

29. A virtual identity platform comprising:
a network service node within a mobile network, for receiving a communication from a mobile communications device attached to the mobile network, the communication including a virtual identity code; and
an identity database accessible by the network service node, the identity database mapping virtual identities to a primary authentication mechanism for the mobile network, the network service node determining a virtual identity for the mobile device based on the virtual identity code and on the primary authentication mechanism and dynamically modifying the communication to include the virtual identity.
